(19) United States
(12) Patent Application Publication
(10) Pub. No.: US 2009/0222887 A1
(43) Pub. Date: Sep. 3, 2009

(54) SYSTEM AND METHOD FOR ENABLING DIGITAL SIGNATURES IN E-MAIL COMMUNICATIONS USING SHARED DIGITAL CERTIFICATES

(76) Inventor: Ram Cohen, Tel Aviv (IL)

Correspondence Address: STITES & HARBISON PLLC, 1199 NORTH FAIRFAX STREET, SUITE 900, ALEXANDRIA, VA, 22314, US

(21) Appl. No.: 12/396,105

(22) Filed: Mar. 2, 2009

(30) Foreign Application Priority Data
Mar. 2, 2008 (IL) 189875

(51) Int. Cl. G06F 21/00

(52) U.S. Cl. 726/2; 709/206

(57) ABSTRACT

A system and method for digitally signing an email communication using a shared digital certificate. The system includes a means for selecting a digital certificate and a matching private key, a header-field editor for populating a sender-field of the digital message with an address associated with the authentication means, and a means for digitally signing the digital message with the private key matching the digital certificate.

### FIELD OF THE INVENTION

The present invention relates to authenticating messages. More particularly, embodiments of the invention relates to a system and method for allowing multiple users to use a common digital signature for email communications.

### BACKGROUND

Digital signatures typically use asymmetric (or private-public) cryptography to verify the authenticity of the source of a digital document. As the name suggests, digital signatures are analogous to handwritten signatures on paper, and like handwritten signatures, digital signatures are generally linked to a single individual.

Digital signature schemes typically use public-private key cryptography, in which a public and private key pair is generated. The public key, combined with user identity information, is then signed by a certification authority to form a digital certificate. The private key is used to sign a document (by encrypting a hash of the document) while the public key (typically obtained directly from the digital certificate that is either embedded or sent with the signed document) is used to decrypt the signature to verify both the identity of the sender and that the message content was not altered after it was signed.

A common standard for a digital certificate is X.509 which defines how a public key and associated attributes are bundled into a single package which can then be digitally signed by another digital certificate.

Digital certificates which are used to sign email communications are generally associated with a single email address. A verifying agent, for example a software application such as an email client, typically verifies that the email address associated with the digital certificate corresponds to the email address of the sender of the email communication. If the sender's email address does not correspond to the digital signature's associated email address, the email communication is not verified and may be considered suspect resulting in a warning being displayed to the recipient.

Within a single organization, however, it may be desirable for a group of individuals to be authorized to use a common digital signature. However, because of the unique nature of the association of the digital signature to a single sender email address, all communications sent by any authorized individuals need to be sent from a single email address. A recipient of the email communication, receiving the email communication from this common email address will not typically know the identity of the specific sender without reading the body of the email.

There is a need to allow multiple senders to use a common digital signature associated with a single email address and the present invention addresses this need.

### SUMMARY OF THE INVENTION

In accordance with a first embodiment, the present invention is directed to providing a system for digitally signing a digital message from a sender, the system comprising: a means for selecting an authentication means; header-field editor for populating a sender-field of the digital message with an address associated with the authentication means; and a means for digitally signing the digital message with the authentication means. Typically, the digital message comprises an email communication and the authentication means comprises a digital certificate and a matching private key.

According to various embodiments of the invention, the header-field editor is further configured to populate a reply-to-field of the digital message with an address associated with the sender. Optionally, the header-field editor is configured to further populate the sender-field with descriptive data associated with the sender. Typically, the descriptive data comprises an address associated with the sender.

In further embodiments of the invention, the authentication means is selected by the sender. Alternatively, the authentication means may be selected automatically according to the contents of the digital message.

Typically, the system comprises executable code carried by a storage medium. Optionally, the system is restricted by at least one restriction from the group consisting of (i) the executable code comprises an email client, (ii) the executable code comprises a plug-in application for an email client, (iii) the executable code comprises a plug-in application for a web browser, (iv) the executable code comprises an add-on application for a web browser and (v) the executable code comprises an add-on software application. According to various embodiments the storage medium is selected from the group consisting of: a computer, a communication device, a mobile telephone, a PDA, a router, a gateway server, a mail server and a proxy server. Optionally, the executable code comprises an application for intercepting communication from the communication device.

In preferred embodiments, the system further comprises a means for verifying that the sender is a member of a set of senders authorized to use the authentication means. The means for verifying that the sender is a member of a set of senders authorized to use the authentication means optionally comprises a software application configured to: intercept an outgoing email communication; compare contents of a sender-field of the email communication with a set of approved email addresses, and transfer the email communication to the header-field editor only if the contents of the sender-field comprise a member of the set of approved email addresses.

It is a further aspect of the invention to teach a method for digitally signing digital messages, the method comprising the following steps:
step (a)—providing a set of approved senders, all members of the set being authorized to use a shared authentication means;
step (b)—intercepting a digital message from a sender;
step (c)—verifying that the sender is a member of the set of approved senders;
step (d)—if the sender is a member of the set of approved senders, populating a sender-field of the digital message with an address associated with the shared authentication means, and
step (e)—signing the digital message with the shared authentication means.

Typically, the method comprises the additional step (f) of populating a reply-to-field of the digital message with an address associated with the sender. Optionally, the method comprises the additional step (g) of further populating the sender-field of the digital message with descriptive data associated with the sender.

In various embodiments of the method the shared authentication means is selected by the sender. Alternatively, the shared authentication means is selected automatically according to the contents of the digital message.

Optionally, the step (c) of verifying that the sender is a member of the set of approved senders, comprises comparing contents of the sender-field of the digital message with a set of approved email addresses.

Typically, the digital message comprises an email communication and the authentication means comprises a digital certificate and a matching private key.

### BRIEF DESCRIPTION OF THE FIGURES

For a better understanding of the invention and to show how it may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention; the description taken with the drawings making apparent to those skilled in the art how the several forms of the invention may be embodied in practice. In the accompanying drawings:

FIG. 1 represents a header of an email communication as known in the PRIOR ART;

FIG. 2A represents a header of another email communication, known in the PRIOR ART, which has been successfully signed with a digital signature associated with the sender address;

FIG. 2B represents a header of another email communication of the PRIOR ART having a digital signature attached which is not associated with the sender address;

FIG. 2C schematically illustrates an alert screen of the PRIOR ART which may be presented to a user attempting to use the digital signature to sign the email communication of FIG. 2B;

FIG. 3 is a block diagram representing the main components of a system for digitally signing email communications which allows multiple senders to use a common digital signature, according to an embodiment of the current invention;

FIG. 4A represents the header of the email communication shown in FIG. 2B as it would appear if signed by a signing system according to an embodiment of the present invention;

FIG. 4B schematically illustrates the email communication of FIG. 4A, as it may be displayed by an email client, and

FIG. 5 is a flowchart representing a method for digitally signing an email communication with a shared digital signature according to another embodiment of the invention.

### DESCRIPTION OF THE PREFERRED EMBODIMENTS

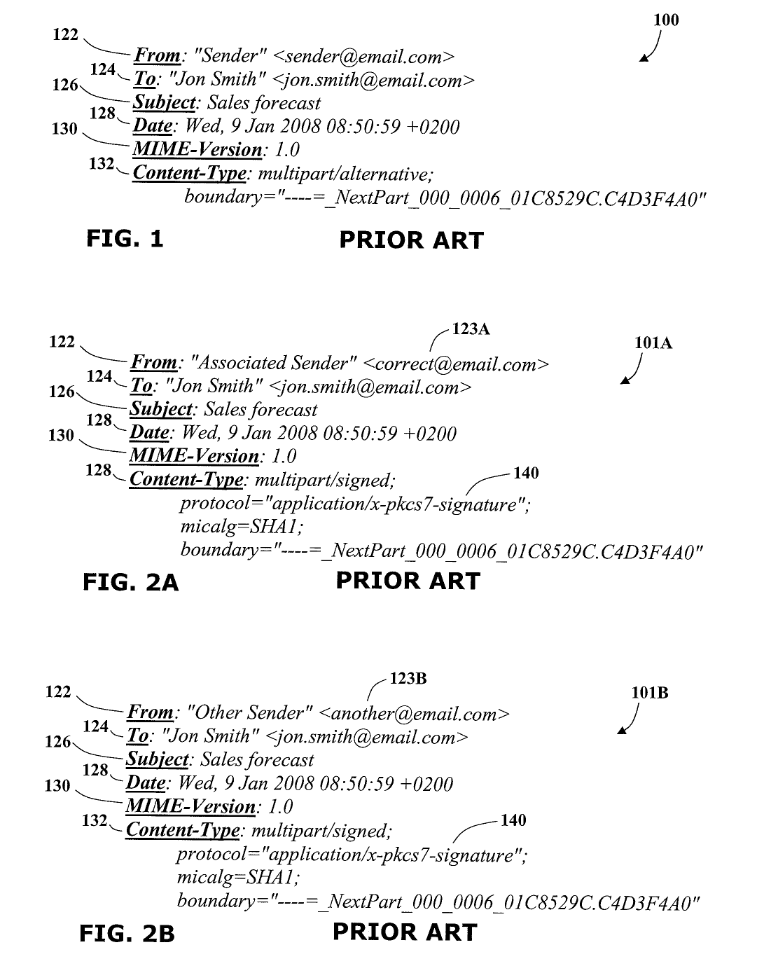

Reference is now made to PRIOR ART FIG. 1 representing the header of an email communication 100. The email communication 100 includes a header 120 and a body (not shown). The header 120 typically includes a number of header-fields, such as the Sender-field 122, To-field 124, Subject-field 126 and a Date-field 128, for example.

The current standard format for Internet e-mail is defined in RFC 2822, which is an updated version of RFC 822. These standards specify the rules pertaining to commonly used header fields. It will be appreciated that in addition to the above-described fields, additional fields (not shown) such as a Reply-To-field, CC-field and BCC-field may also be provided.

The Sender-field 122, (often called the From-field) denotes the email address of the sender of the email communication and may also includes descriptive information such as the displayed name of the sender. The To-field 124 denotes the email address to which the email communication is to be sent and may also include descriptive information such as the displayed name of the addressee. Descriptive information is typically shown within quotation marks. The Subject-field 126 denotes the subject of the email communication as defined by sender, and the Date-field 128 denotes the date and time that the email message is sent.

According to various common email format protocols, an email address comprises an actual address within angle brackets (<>) and descriptive information is provided within quote marks (“”). For example, in the email address
“Jon Smith” <jon.smith@email.com>
   the actual email address is jon.smith@email.com, which is used to determine the destination of an addressee whereas the term Jon Smith is descriptive information, which does not effect the destination to which a communication is sent. Thus an email communication having any of the following contents of the To-field:

“Jon Smith” <jon.smith@email.com>
“Jonny” <jon.smith@email.com>
“Marketing” <jon.smith@email.com>

will be sent to the same destination address, namely jon.smith@email.com. It will be appreciated that other email formats will differ from this example.

Additional attributes of a message may be provided by Multipurpose Internet Mail Extensions (MIME) which define a collection of standard e-mail headers as well as a set of transfer encodings which can be used to represent 8-bit binary data using characters from the 7-bit ASCII character set. Moreover, MIME also specifies rules for encoding non-ASCII characters in e-mail message headers, such as the Subject-field 126, allowing these header fields to contain non-English characters. MIME is specified in several RFCs such as RFC 2045, RFC 2046, RFC 2047, RFC 4288, RFC 4289 and RFC 2077. The MIME-field 130 denotes the version of MIME with which the communication complies. The Content-Type-field 132 denotes the type of the content according to MIME.

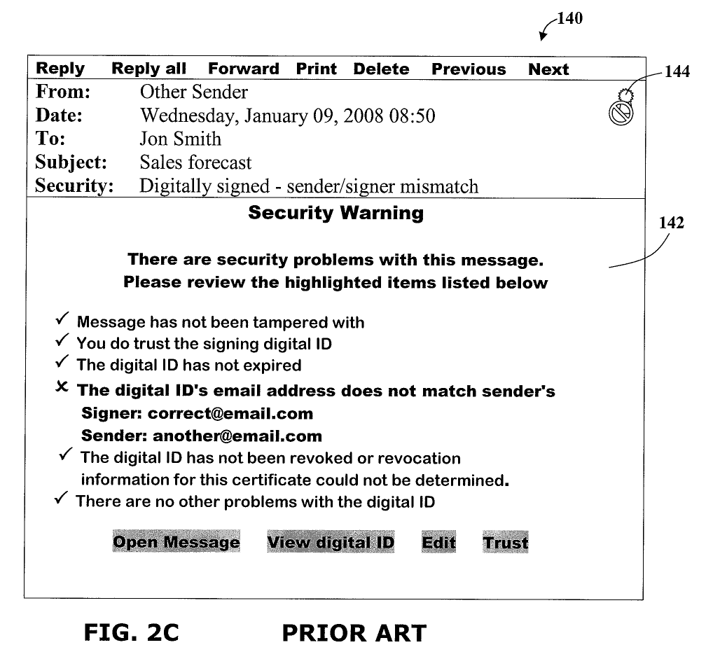

Referring now to PRIOR ART FIGS. 2A and 2B, representing further email communications 101A, 101B, it will be noted that the headers 120 of both email communications now include additional information relating to a digital signature.

The lines:

protocol=“application/x-pkcs7-signature”;
micalg=SHA1;

denote that the message was digitally signed, according to the S/MIME standard specified in RFC 2633, with the signature x-pkcs7-signature 140.

Typically, a digital certificate is associated with a single sender email address. The associated sender email address may be included in an attribute of the digital certificate, typically the ‘Subject’ attribute. Software applications (signing agents) which digitally sign an email communication, generally require that the sender email address 123A appearing in the Sender-field 122, of the header is identical to the email address specified in the digital certificate.

The digital signature of the example is associated with the sender email correct@email.com. Note that in the email communication 101A of FIG. 2A, the associated email address, correct@email.com, appears in the Sender-field 122. In this case the signed email communication is sent to the addressee.

In contrast, in the email communication 101B of FIG. 2B, a different email address 123B, another@email.com, appears in the Sender-field 122. Because this is not the email address associated with the digital certificate, the email communication is not signed. Typically, the mail client will alert the user of the anomaly and prompt for further instructions. Furthermore, if the mail client does send the message to a recipient, the mail client of the recipient may issue a security warning (as shown in FIG. 2C) alerting of the discrepancy between the sender e-mail address and the e-mail address embedded in the signing digital certificate.

It will be apparent that the prior art verification systems described above are not suitable for applications where a group of senders are all authorized to use a common digital signature.

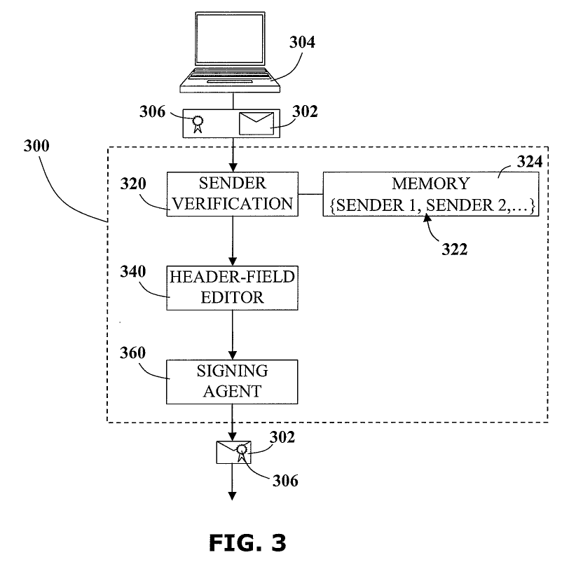

Reference is now made to FIG. 3 which is a block diagram representing the main components of a system according to one embodiment of the current invention which allows multiple senders to use a common digital signature. The system 300 is configured to digitally sign an email communication 302 submitted by a sender 304 with a digital signature 306. The system 300 includes a sender verification module 320, a header-field editor 340 and a signing agent 360.

When the sender 304 submits an email communication 302 for digital signing, the sender verification module 320 is configured to verify that the sender 304 is authorized to use the selected digital signature 306. Typically the sender verification module 320 compares the sender 304 of the submitted email communication 302 with the members of a set of authorized senders 322. In some embodiments, the set of authorized senders 322 may be stored in a memory 324 of the sender verification module 320. Alternatively, the sender verification module 320 is in communication with an external storage medium such as a database or a directory server or the like, in which the set of authorized senders is stored.

If the sender 304 of the email communication 302 is a member of the authorized set 322, the sender verification module 320 transfers the email to the header-field editor 340. If, however, the sender is not a member of the authorized set 322, the email communication 302 may be sent without further processing.

The header-field editor 340 is configured to edit the header-fields of approved email communications 302. In particular, the sender-field of an email communication may be edited to include an address associated with the selected digital signature 306. Preferably, descriptive data is also added to the sender-field to provide the recipient of the email with information regarding the specific sender 304 of the email communication 302. Typically, this descriptive data includes contact details of the sender 304 such as the name, email address and the like.

The header-field editor 340 may be further configured to add or edit a reply-to field of the email communication 302 so as to include a return email address selected by the sender 304. Usefully a default may be provided in which the unedited original contents of the sender-field are copied into the reply-field. In this way, a recipient of the email communication 302 may directly reply to the actual sender 304.

The signing agent 360 is configured to digitally sign the email communication 302 using the private key that matches the selected digital signature 306, typically according to the S/MIME standard (described in RFC 2311 and 2312). It will be apparent that, because the sender-field of the email communication 302 has been edited to include the email address associated with the selected digital signature 306, the email communication 302 would not trigger the security alert as shown in FIG. 2C in the addressee mail client.

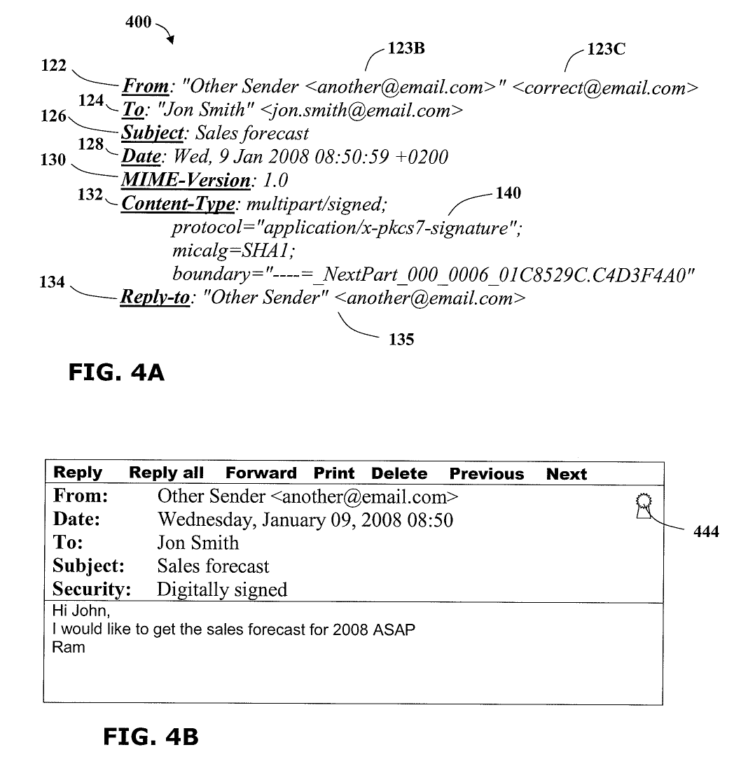

Reference is now made to FIG. 4A which represents the email communication 101B shown in FIG. 2B as it would appear if signed by a signing system according to an embodiment of the present invention. The following manipulations have been carried out in the header of the email message:
The Reply-To-field 134 has been added to the header.
The Reply-To-field 134 has been filled with the original contents of the Sender-field 135.
The Sender-field 122 has been edited such that the original contents 123B appear as descriptive data whereas the actual email address 123C has been edited to match the email address associated with the digital certificate used to sign the message.

Thus, although the contents of the Sender-field correspond to the email address associated with the digital certificate, when the recipient replies to the message, it is directed to the email address of the specific sender as specified in the Reply-To-field.

Moreover, the ‘From’ value as displayed by the addressee mail client shows the name and mail address of the original sender 135.

FIG. 4B schematically illustrates the email communication 400 of FIG. 4A, as it may be displayed by an email client. Note that a certificate icon 444 indicates that the email message has been successfully verified, in contrast to the icon 144 (FIG. 2C) indicating a problem with verifying the email communication.

Typically, the system includes executable code, such as an email client, a plug-in application for an email client or an add-on software application. The executable code may be carried by a storage medium, such as a computer, a communication device, a mobile telephone, a PDA or the like. Alternatively, the storage medium may be a remote device such as a router, a gateway server, a mail server, a proxy server or the like.

It will be appreciated that in various embodiments of the current invention, the system for digitally signing an email communication may be integrated with a variety of email clients used to manage email such as Mozilla Thunderbird®, Microsoft Outlook® for example. According to embodiments of the current invention, the system for digitally signing may be implemented as a software application such as a module of the email client or a plug-in to the email client or a plug-in/add-on to a web browser. Such a software application is typically a program that interacts with a host application to provide additional functionality. Alternatively, however, the system may be implemented as any application running on a communication device. Furthermore, the email client may be a Web browser interacting with a remote email server such as Hotmail™, Gmail™ or the like. According to other embodiments of the invention, the system for digitally signing may be implemented by a remote server, such as a mail server, proxy server or gateway server, deployed between the sender's computer and the destination mail server,

According to still further embodiments of the invention, the sender of an email communication may be provided with the option to select a desired signing certificate from a plurality of available certificates. The selection may be based on which certificate represents best the authority of the mail content, even if the mail address of the certificate differs from his/her mail address.

Alternatively, the digital signature may be selected automatically, based upon the content of the communication. For example information such as the organizational function of the sender, the intended recipients, key words of the message or its attachments, may be used to select which of the available digital certificates should be used for signing the communication, or indeed if the communication should be signed at all. In this regard, it will be appreciated that organizations may enforce a central signature policy for email communications that are routed through a common server.

By way of illustrative example only, a server may use two digital certificates for digitally signing an email communication: the first digital certificate with the mail address management@email.com, and the second with the mail address sales@email.com.

The server may apply rules such as:
1. If the sender of the communication is bob@email.com the message should be digitally signed with the management@email.com certificate.
2. If the text of the communication or the text of any attachment attached to the message contains the phrase ‘offer’ or ‘price quote’, for example, the message should be signed with the sales@email.com certificate.
3. If the communication subject contains the phrase ‘SIGN’ the message should be signed with the sales@email.com certificate.
4. If none of the above mentioned rules applies to an email communication, the email communication should not be signed.

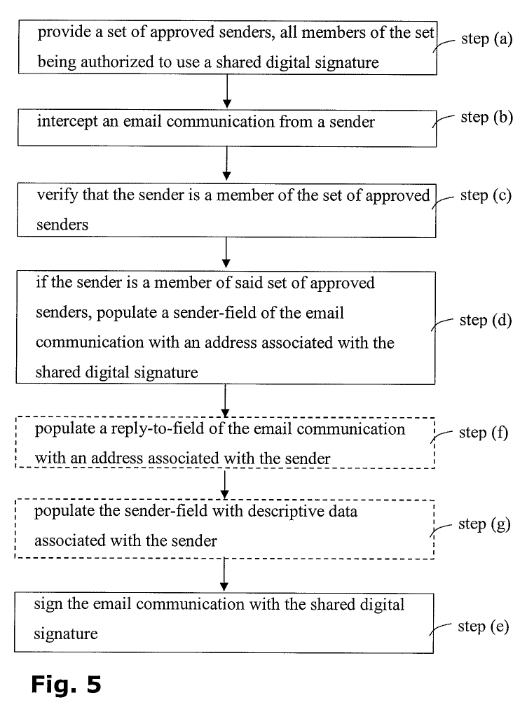

Reference is now made to FIG. 5 showing a flowchart representing the main steps of a method for digitally signing an email communication with a shared digital signature according to a further embodiment of the invention. The method includes the following steps: step (a)—providing a set of approved senders, such that all members of the set are authorized to use a shared digital signature; step (b)—intercepting an email communication from a sender; step (c)—verifying that the sender is a member of the set of approved senders; step (d)—if the sender is a member of the set of approved senders, populating a sender-field of the email communication with an address associated with the shared digital signature; step (e)—signing the email communication with the shared digital signature; step (f)—populating a reply-to-field of the email communication with an address associated with the sender, and step (g)—further populating the sender-field with descriptive data associated with the sender.

Thus, embodiments of the invention allow a group of authorized users to sign a digital communication, such as an email communication, using a common digital certificate associated with a single sender email address. Although all such signed communications are sent from the same email address, a recipient of the communication is provided with information regarding the specific member of the authorized group who sent the email. The scope of the present invention is defined by the appended claims and includes both combinations and sub combinations of the various features described hereinabove as well as variations and modifications thereof, which would occur to persons skilled in the art upon reading the foregoing description.

In the claims, the word “comprise”, and variations thereof such as “comprises”, “comprising” and the like indicate that the components listed are included, but not generally to the exclusion of other components.

1. A system for digitally signing a digital message from a sender, said system comprising:
a means for selecting an authentication means;
a header-field editor for populating a sender-field of said digital message with an address associated with said authentication means; and
a means for digitally signing said digital message with said authentication means.

2. The system of claim 1, wherein the digital message comprises an email communication and said authentication means comprises a digital certificate and a matching private key.

3. The system of claim 1 wherein the header-field editor is further configured to populate a reply-to-field of said digital message with an address associated with said sender.

4. The system of claim 1 wherein the header-field editor is configured to further populate said sender-field with descriptive data associated with said sender.

5. The system of claim 4 wherein said descriptive data comprises an address associated with said sender.

6. The system of claim 1 wherein said authentication means is selected by said sender.

7. The system of claim 1 wherein said authentication means is selected automatically according to the contents of said digital message.

8. The system of claim 1 comprising executable code carried by a storage medium.

9. The system of claim 8 comprising a restriction from the group consisting of (i) said executable code comprises an email client, (ii) said executable code comprises a plug-in application for an email client, (iii) said executable code comprises a plug-in application for a web browser, (iv) said executable code comprises an add-on application for a web browser and (v) said executable code comprises an add-on software application.

10. The system of claim 8 wherein said storage medium is selected from the group consisting of: a computer, a communication device, a mobile telephone, a PDA, a router, a gateway server, a mail server and a proxy server.

11. The system of claim 10 wherein said executable code comprises an application for intercepting communication from said communication device.

12. The system of claim 1 further comprising a means for verifying that said sender is a member of a set of senders authorized to use said authentication means.

13. The system of claim 12 wherein said means for verifying that said sender is a member of a set of senders authorized to use said authentication means comprises a software application configured to:
intercept an outgoing email communication;
compare contents of a sender-field of said email communication with a set of approved email addresses, and
transfer said email communication to said header-field editor only if said contents of said sender-field comprise a member of said set of approved email addresses.

14. A method for digitally signing digital messages, said method comprising the following steps:
step (a)—providing a set of approved senders, all members of said set being authorized to use a shared authentication means;
step (b)—intercepting a digital message from a sender;
step (c)—verifying that said sender is a member of said set of approved senders;
step (d)—if said sender is a member of said set of approved senders, populating a sender-field of said digital message with an address associated with said shared authentication means, and
step (e)—signing said digital message with said shared authentication means.

15. The method of claim 14 comprising the additional step (f) of populating a reply-to-field of said digital message with an address associated with said sender.

16. The method of claim 14 comprising the additional step (g) of further populating said sender-field of said digital message with descriptive data associated with said sender.

17. The method of claim 14 wherein said shared authentication means is selected by said sender.

18. The method of claim 14 wherein said shared authentication means is selected automatically according to the contents of said digital message.

19. The method of claim 14 wherein said step (c) of verifying that said sender is a member of said set of approved senders, comprises comparing contents of said sender-field of said digital message with a set of approved email addresses.

20. The method of claim 14, wherein said digital message comprises an email communication and said authentication means comprises a digital certificate and a matching private key.
